(19) United States
(12) Patent Application Publication
(10) Pub. No.: US 2010/0322697 A1
(43) Pub. Date: Dec. 23, 2010

(54) Capless Writing Instrument

(75) Inventors: Franck Rolion, Asnieres Sur Oise (FR); Bertrand Baudoin, Paris (FR)

Correspondence Address: JONES DAY, 222 EAST 41ST ST, NEW YORK, NY, 10017, US

(73) Assignee: Societe BIC, Clichy (FR)

(21) Appl. No.: 12/446,177

(22) PCT Filed: Oct. 15, 2007
(86) PCT No.: PCT/FR2007/052160

§ 371 Date: Apr. 17, 2009

(30) Foreign Application Priority Data
Oct. 18, 2006 (FR) 06 09158

(51) Int. Cl. B43K 7/12

(52) U.S. Cl. 401/107

(57) ABSTRACT

A writing instrument that includes a barrel extending longitudinally from a rear end to a forward end having an opening; a writing member having a writing tip at a forward end longitudinally movable inside the barrel between a retracted position and an extended position for which the writing tip projects through the forward opening; a sealing sleeve that can move longitudinally inside the barrel along a predetermined stroke between a withdrawn position and an advanced position and having rear and forward ends presenting rear and forward openings respectively, through which the writing member can slide, where the sealing sleeve is propelled between positions by the writing member when the latter is moved between the retracted and extended positions; and a closure device able to allow the passage of the writing member through the forward openings of the sleeve and barrel when the sleeve is in the advanced position, and substantially to seal off the forward opening of the sleeve when the latter is in the retracted position with the writing tip housed inside said sleeve.

This application is a national stage application of International Application No. PCT/FR2007/052160, filed on Oct. 15, 2007, which claims priority to French Patent Application No. 06 09158 filed on Oct. 18, 2006, the entire contents of both applications being incorporated herein by reference.

### BACKGROUND OF THE INVENTION

### Field of the Invention

The embodiments of the present invention relate to writing instruments of the cap-less type, usually named “capless,” in which the writing tip can be protected in an airtight compartment. This is a particular advantage for the tips of instruments such as felt pens, highlighters and markers.

More specifically, the embodiments of the present invention relate to a writing instrument comprising:
a barrel extending longitudinally from a rear end to a forward end having an opening;
a writing member having a writing tip at a forward end and longitudinally movable inside the barrel between a retracted position and an extended position for which the writing tip projects through the forward opening;
a sealing sleeve longitudinally movable inside the barrel along a predetermined stroke between a withdrawn position and an advanced position and having rear and forward ends presenting rear and forward openings respectively, through which the writing member can slide, said sealing sleeve being propelled between said positions by the writing member when the latter is moved between the retracted and extended positions; and
a closure device able to allow the passage of the writing member through the forward openings of the sleeve and barrel when the sleeve is in the advanced position, and to close the forward opening of the sleeve in a substantially airtight manner when the latter is in the retracted position with the writing tip housed inside said sleeve.

A writing instrument of this kind is known from, in particular, document EP-A-1422075. Because of the movement of the sealing sleeve described in that document, a relative movement takes place between the closure device, which is in the form of a shutter, and the barrel. This relative movement enables positive command of the movements of the shutter and enables a closure position to be obtained with a slight mechanical stress which improves the airtightness. In other embodiments, the movement of the sealing sleeve relative to the barrel could be exploited to improve the airtightness of the space defined at least partly by this sleeve with a closure device connected to the barrel.

However, the fact that the sealing sleeve has to be moved along a stroke that is necessarily shorter than the stroke of the writing member, can have disadvantages on the ergonomic comfort of the instrument. More specifically, when the user moves the tip from the retracted position to the extended position, the engagement of the writing member with the sealing sleeve can produce a hard spot in the course of this movement, even to the point of dissuading the user from finishing the extension of the writing tip. The problem is that, in the particular case of the instrument described in document EP-A-1422075, the sealing sleeve is propelled by the engagement of a projecting bead on the writing member with an annular groove in the inside wall of the sleeve. This engagement keeps these parts together from the withdrawn position of the sleeve shown in FIG. 1 of that document, to the advanced position of the sleeve shown in FIG. 7, where the closure device assumes an open position. To continue the movement of the writing member as far as the extended position shown in FIG. 6, the user has to exert a force sufficient to pull the bead out of the annular groove, creating a disagreeable sensation of a hard spot.

It is therefore an object of an embodiment of the present invention to improve the comfort of use of a capless writing instrument, while keeping a movable sealing sleeve and its attendant advantages from the point of view of sealed closure from the forward end.

For this purpose an embodiment of the present invention relates to a writing instrument of the type indicated earlier, characterized in that the sealing sleeve comprises on a radially inward face a first engagement portion, and in that the writing member has on a radially outward face a second engagement portion, said first and second engagement portions being arranged longitudinally and designed in such a way as to engage with each other with friction to create a connecting force between the writing member and the sleeve greater than the force required to move said sleeve from its withdrawn position to its advanced position, and to create between themselves at least one substantially airtight annular zone when the writing member and the sleeve are in the retracted position and withdrawn position respectively, at least one of said first and second engagement portions being a frustoconical surface coaxial with the longitudinal axis and having its apex directed toward the rear.

Because of the engagement between the engagement portions creating a connecting force between the sleeve and the writing member, it is possible to advance the sleeve by means of the writing member. However, in contrast to a snap connection of these parts, the engagement portions, at least one of which is frustoconical, can be disconnected by a force slightly greater than the force required to advance the sleeve, and in any case a force much smaller than that required to separate the snap connections of the prior art. What is more, the frustoconical surface or surfaces can be designed in such a way that their disengagement is significantly less sudden than with a snap engagement, because the frictional force can reduce to zero more slowly when the writing member separates from the sleeve if a slight taper is adopted. Various parameters of the engagement portions can be adjusted to obtain the desired characteristics concerning the force of the resulting connection, the suddenness of the loss of engagement with friction, and the airtightness obtained. Of these parameters, the following may be noted: geometrical parameters, such as primarily the cone angle, length and diameter of the frustoconical surfaces; but also parameters related to the type of material forming either or both of these portions and their surface condition.

### SUMMARY OF THE INVENTION

Preferred embodiments of the invention also make use of one or other of the following provisions:
the first engagement portion is a frustoconical surface coaxial with the longitudinal axis and having its apex directed toward the rear;
the second engagement portion is a frustoconical surface complementary with the first portion;
the cone angle of the first engagement portion is less than or equal to the cone angle of the second engagement portion, the respective cone angles of the first and second portions being preferably approximately equal;
the other of said first and second engagement portions is a surface having at least two projecting annular reliefs spaced apart in the longitudinal direction, the vertices of said at least two reliefs being inscribed in a frustoconical volume complementary to said frustoconical surface.
the cone angle of said at least one frustoconical surface is from 2 to 5 degrees measured at the diameter, and preferably about 3 degrees;
at least one of said first and second engagement portions has an elastically deformable surface;
the first engagement portion has an elastically deformable surface while the second engagement portion has a rigid surface;
said at least one elastically deformable surface is an elastomeric part formed in one piece with a rigid part belonging to the sealing sleeve or to the writing member;
the sealing sleeve is formed entirely of elastomer;
the first and second engagement portions are hard surfaces with little roughness, preferably made of a rigid plastic; and
the friction engagement of the first and second portions creates a connecting force of from 2 to 10 newtons.

### BRIEF DESCRIPTION OF THE DRAWINGS

Other features and advantages of the invention will become apparent in the course of the following description, given by way of example, with reference to the appended drawings, in which:

FIG. 1 is an exploded view of a writing instrument comprising a writing member and a sealing sleeve in a first embodiment of the invention;

FIG. 2 is an enlarged view in partial cross section of the writing member and sleeve shown in FIG. 1;

FIG. 3 is a longitudinal cross section through the writing instrument shown in FIG. 1 with the writing member in the retracted position;

FIG. 4 is a view similar to FIG. 3 with the writing member in the extended position; and

FIG. 5 is an enlarged cross section through a writing member and sleeve in a second embodiment of the invention.

### DETAIL DESCRIPTION OF THE DRAWINGS

In the various figures, identical references denote identical or similar parts.

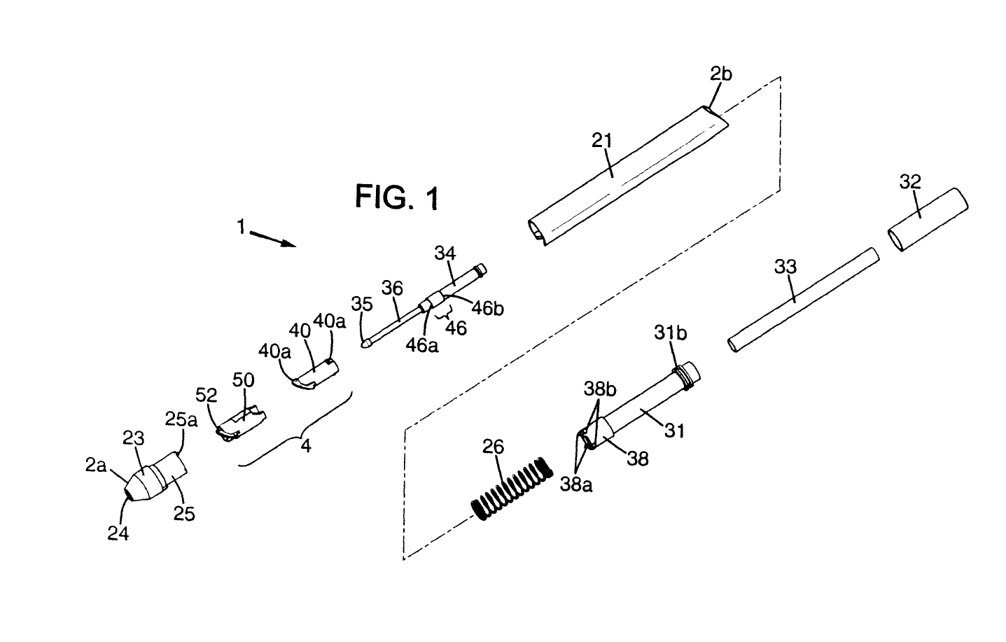

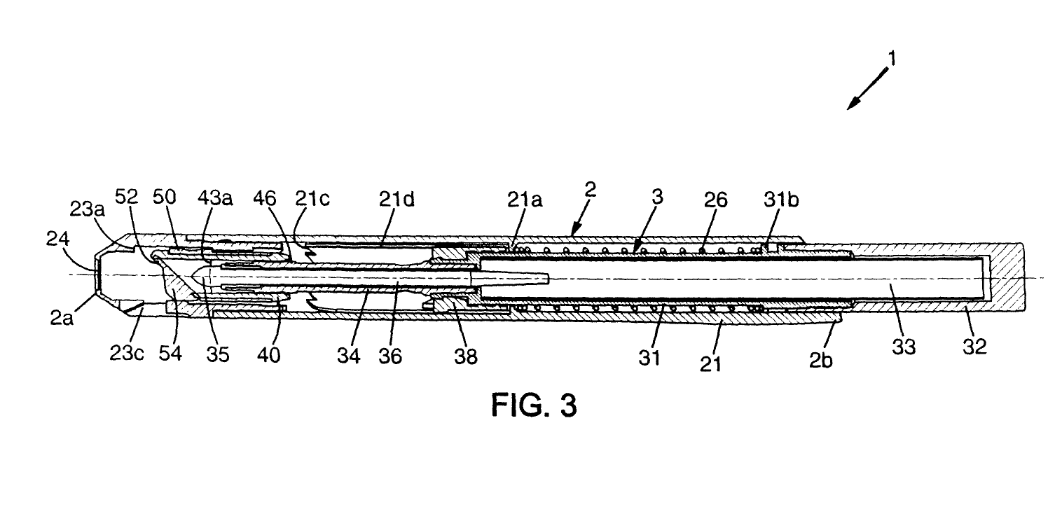

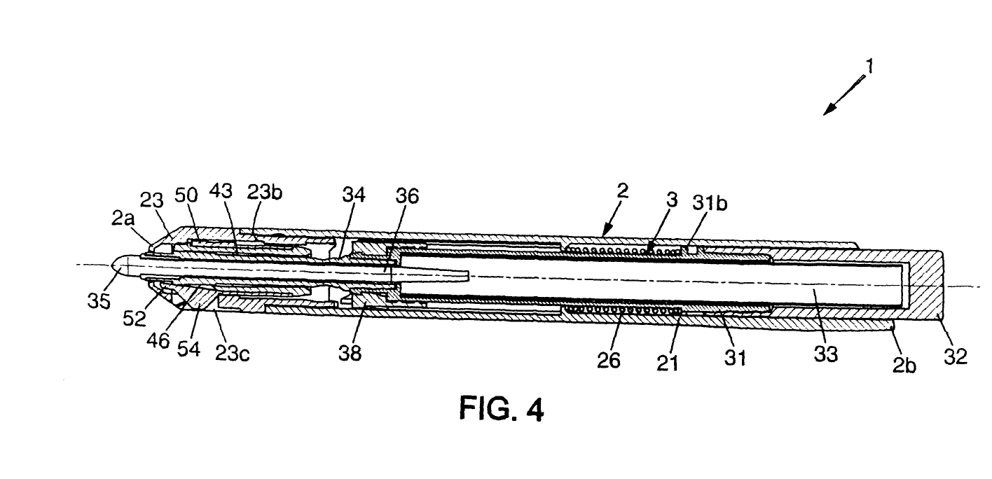

FIGS. 3 and 4 show schematically in cross section a writing instrument 1 that comprises a barrel 2 extending longitudinally between a forward end 2a and a rear end 2b. As can be seen more clearly in FIG. 1, the barrel is made up of two parts, a main tubular body 21 and a collar 23. The collar 23 preferably has an opening 24 at the forward end 2a, and a rearward tubular projection 25 allowing it to be fitted by insertion into the tubular body 21. The free end of the annular projection 25 has a number of teeth 25a whose function will be described later.

As seen in FIG. 3, the inside wall of the main body 21 of the barrel 2 comprises a cam track in the form of sawteeth 21c connected to grooves 21d extending longitudinally toward the rear.

The barrel 2 comprises a writing member 3. As FIG. 1 shows more clearly, the writing member 3 comprises a reservoir 31 closed at its rear end by a socket 32 and containing an ink-soaked pad 33. The writing member 3 is continued at the forward end of the reservoir 31 by a tube 34. On the forward end of the tube 34 is a fiber writing tip 35. The writing tip 35 is joined to a connector 36 extending along the tube 34 as far as the pad 33 for the supply of ink.

The writing member 3 is therefore of the felt-tip type with a capillary reservoir, but it could be a free-ink reservoir, or a ballpoint. The ink contained in the reservoir is selected according to the type of instrument—felt-tip, marker, highlighter or ballpoint pen, but it could also be correcting fluid.

At the front of the reservoir 31, the writing member 3 has a ring 38 with end teeth 38a and radial spurs 38b.

The writing member 3 is able to move translationally inside the barrel 2 between a retracted position shown in FIG. 3, in which the spurs 38b abut against the rear end of the grooves 21d of the barrel, and an extended position shown in FIG. 4 in which the spurs 38b bear against the sawtooth cam track 21c, and in which the writing tip 35 has protruded through the opening 24 in the barrel 2. The rotation of the ring 38 which is required for the radial spurs 38b to move from the grooves 21d to the sawteeth 21c is produced in a known manner by the interaction of the end teeth 38a with the teeth 25a on the tubular projection of the collar 23.

A compression spring 26 between a radially inward shoulder 21a on the barrel 2 and a hoop 31b around the reservoir 31 keep the writing member 3 permanently stressed toward the end 2b.

The socket 32 on the rear of the reservoir forms an actuating member which is movable longitudinally under the action of a user, and against the action of the compression spring 26, to move the writing tip 35 from the retracted position to the extended position and vice versa. However, the control member for extending/retracting the writing tip could be very different: it could for example be a rotating portion of the barrel, or a button which is depressed radially with respect to the longitudinal direction of the barrel. Similarly the mechanism that keeps the writing member in the retracted and extended positions could be very different.

The barrel 2 also has a sealing device 4 whose function is to confine the writing tip 35 in an airtight space, or at least a space that is sufficiently airtight to prevent the tip drying out or premature evaporation of the ink from the reservoir when the writing member 3 is in the retracted position—that is, when the writing instrument 1 is not being used.

The sealing device 4 comprises a sleeve 40 surrounded externally in the embodiment illustrated by a sheath 50. The sleeve 40 is basically tubular in shape with a forward opening 41 through which the writing tip 35 and the tube 34 carrying this tip can slide, as well as a rear opening 42 through which a small-diameter portion of the tube 34 can slide freely. The outer surface of the sleeve 40 includes projections 40a to immobilize the sheath 50. The sleeve 40 radially defines the airtight space designed to contain the writing tip 35 when retracted. The sleeve 40 is advantageously a single elastomeric component, giving it a degree of elasticity.

The outer sheath 50 is snap-fastened permanently to the sleeve 40. The sheath 50 is made of a hard plastic in order to give the assembly a certain rigidity and encourage the translational movement of the sealing device 4, and hence of the sleeve 40, inside the barrel 2.

The collar 23 has a forward longitudinal stop 23a visible in FIG. 3 and a rear longitudinal stop 23b visible in FIG. 4, which limit the movement of the sealing device 4 to a predetermined travel. The sleeve 40 is therefore movable between a withdrawn position shown in FIG. 3 and an advanced position visible in FIG. 4.

The sealing device 4 comprises a shutter 52 hinged to the sheath 50 by an integral plastic hinge 53. The shape of the shutter 52 is designed to cover the forward opening 41 of the sleeve and it has a right-angled projection 54 that can drop into an opening 23c in the collar 23. The fact that the sleeve 40 is elastically deformable around the opening 41 creates a better seal with the shutter 52.

The movement of the sealing device 4 between the advanced and withdrawn positions causes the shutter 52 to move respectively between the open position, in which it allows the writing tip 35 to pass through, and the closed position, in which it closes and substantially seals the forward opening 41 of the sleeve 40. The shutter 52 thus constitutes a closure device, and for more details on its operation the reader may refer to document EP-A-1422075.

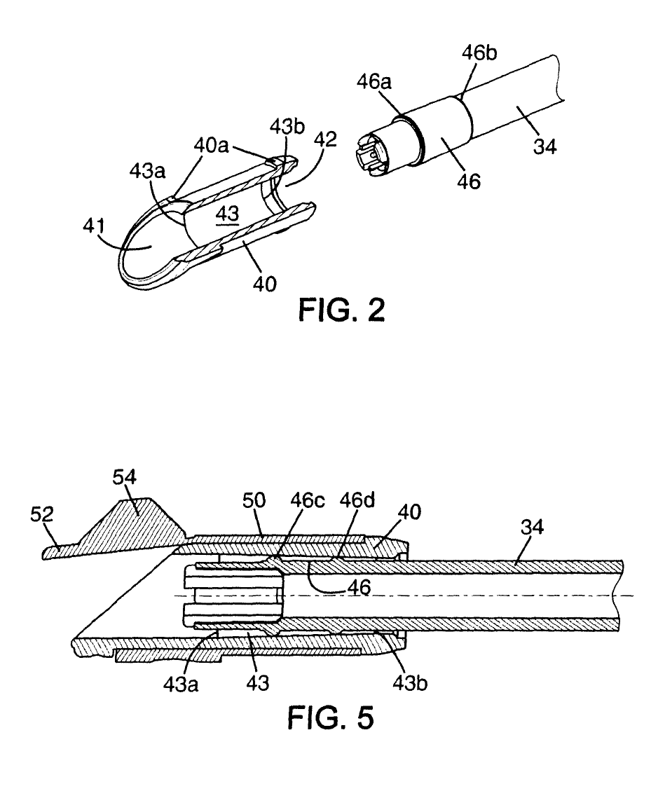

As seen more clearly in FIG. 2, the sealing sleeve 40 comprises a first engagement portion 43 and the writing member 31 has a second engagement portion 46. These two engage with each other when the writing member 3 is in the retracted position shown in FIG. 3.

More specifically, the engagement portion 43 of the sealing sleeve 40 is formed on the radially inward face of this sleeve and extends from approximately the rear opening 42 forward more than halfway along the sleeve. It is a frustoconical surface extending from a circular base 43a to a apex 43b which has a smaller diameter at the base and is situated towards the rear opening 42 of the sleeve. As a result, when the sleeve 40 is fitted into the writing instrument 1, the first engagement portion 43 is a frustum of a cone coaxial with the longitudinal axis, its apex pointing towards the rear end 2b.

The second engagement portion 46 belonging to the writing member 3 is more specifically a frustoconical shape formed on a radially outward annular face of the writing member 3 which fits into the sealing sleeve 4, and more specifically is a portion of the surface of the tube 34 carrying the writing tip 35. The frustoconical surface of the second engagement portion 46 is complementary to the frustoconical surface of the first engagement portion 43, i.e. they have cone angles measured at the diameter that are within a few tenths of a degree of each other.

Furthermore, the diameter of the base 46a of the second engagement portion 46 situated toward the front has a value between the diameter of the base 43a and the diameter of the apex 43b of the first frustoconical engagement portion 43. The rear diameter 46b of the second engagement portion is less than the diameter of the forward end 46a of this portion which is therefore also a apex portion pointing toward the rear. Thus, when the writing member 3, passing through the sealing sleeve 40, is pulled back, the first and second engagement portions (43, 46) contact each other, in this case over a major part of their surfaces.

It will be observed that with the illustrated mechanism, the spring 26 which urges the writing member 3 toward the rear ensures that a certain traction is exerted by the second engagement portion 46 on the first portion 43, because the sealing sleeve 40 is locked in its withdrawn position by the rear stop 23b on the collar 23 while the writing member 3 in the retracted position is still experiencing the return force of the spring 26 because the ring 38 on the latter is not yet in contact with the inside shoulder 21a on the barrel 2.

The interaction of the two engagement portions (43, 46), which in this case are both formed by frustoconical surfaces, ensures that the rear end of the sleeve 40 is sealed off: these coaxial surfaces, each of the same taper, create a region of contact with each other that extends all the way around the perimeter of the engagement portions (43, 46) and over a major part of the longitudinal length of these portions. In this way the seal created at the rear end of the sleeve 40 is precisely comparable with that obtained by fitting a cap onto a barrel and, because the forward opening 41 is closed by the shutter, the writing tip 35 is protected in the retracted position.

In addition, the interaction of the engagement portions (43, 46) creates a clamping force and a frictional engagement between the writing member 3 and the sleeve 40 due to the frustoconical shape of at least one of these portions. The connecting force thus created is advantageously put to use to drive the sleeve 40 from the withdrawn position shown in FIG. 3 to the advanced position shown in FIG. 4, when the writing member 3 is pushed manually into the extended position by depressing the rear button 32. When the sealing sleeve 40, or more precisely the sheath 50 attached to it, reaches its forwardmost position, the pressure exerted by the user releases the engagement portion 46 of the writing member 3 from the engagement portion of the sleeve 40, to move the writing tip 35 through the forward opening 41 in the sleeve, and through the opening 24 in the instrument, to reach the extended position.

The temporary connecting force created between the writing member 3 and the sleeve 40 must be sufficient to drive the sealing device 4 from its withdrawn position to its advanced position while operating the closure device formed by the shutter 52. For the embodiment depicted, a connecting force of at least 2 newtons is sufficient to ensure forward movement of the sealing device 4, but the minimum connecting force could be greater for other types of pen. Furthermore, besides the fact that the disengagement of the portions (43, 46) constructed in accordance with the invention is less sudden than a snap engagement, it is possible to modify the force required to separate the writing member 3 from the sleeve 40 to a very low value, of around a few newtons and preferably not more than 10 newtons, so that the instrument is very easy to manipulate and separation is almost imperceptible.

The features of the engagement portions (43, 46) may be modified perceptibly in order to modify the connecting force to a value that gives a good compromise between comfort of use and certainty of driving of the sealing sleeve 40, as well as a good compromise between the value of this force and the degree of airtightness desired between the engagement portions (43, 46). Such parameters that may be cited include parameters relating to the geometry of the surfaces, such as for example the cone angle, the shape of the surface of one of the engagement portions with respect to the frustoconical surface of the other, and the diameter and length of these surfaces.

Other parameters are also involved, such as the type of material from which these parts are made, and more particularly the features of the surfaces of the engagement portions made from these materials.

For example, the cone angle of the engagement portions (43, 46) measured on a diameter of the frustoconical surfaces is small, from 2 to 5 degrees, and preferably about 3 degrees, as in the embodiment illustrated, particularly in order to increase the connecting force and achieve a progressive disengagement.

However, it is preferable that the cone angle of the first engagement portion 43, i.e. the female portion connected to the sleeve 40, be less than or equal to the cone angle of the second portion, or at least to adopt specifications for the molds, in order to obtain this configuration rather than the reverse configuration, despite the inevitable scatter of manufacturing dimensions. What happens is that, with a smaller taper for the female part, a region of contact is obtained between the engagement portions (43, 46) which is further forward on a larger-diameter region. This improves airtightness and reduces the volume of the airtight space.

For the same purpose, but also in order to improve airtightness, one of the engagement portions is made of an elastomer so that its surface is elastically deformable to the loads applied. In the embodiment shown, it is the female engagement portion 43, i.e. that portion of the sleeve 40 which is made entirely of elastomer. It will be seen that the radial expansion of the sleeve 40 is limited by the rigid outer sheath 50. Therefore there is no risk of the writing member 3 coming out through the rear end 42 of the sleeve, or of the sealing device 4 becoming stuck inside the barrel 2.

However, the second engagement portion 46 is made of a rigid plastic molded integrally with the tube 34. This arrangement of the deformable and rigid surfaces would seem to be preferable for the disengagement and for guidance of the sliding movement, but it would be conceivable to reverse the deformable and rigid surfaces of the engagement portions (43, 46), or even to have deformable surfaces for the first and second engagement portions.

As a variant of the embodiment shown, in which the elastomer sleeve 40 is fitted into the sheath 50, it may be advantageous for one of the engagement portions to be formed by an elastomer part that is twin-shot injection molded or overmolded onto a rigid plastic sleeve, or onto a part of the writing member that passes into the sleeve. This gives a single, substantially rigid component, of which only the part performing the engagement portion function has the desired surface elasticity, which can in particular simplify the assembly of the writing instrument.

In a variant, it is also possible for both the first and second engagement portions to have hard surfaces made from the same rigid plastic as the rest of the corresponding component. This simplifies the manufacture of the components. However, the surface condition of the engagement portions must then be adapted to ensure a good compromise between airtightness and the connecting force obtained by the engagement. For this purpose it would appear to be preferable to adopt rigid engagement surfaces having a slight roughness, specifically a surface whose arithmetic mean deviation Ra of the asperities with respect to the mean line is less than or equal to 1.6 micrometers.

In the first embodiment shown in FIGS. 1-4, the two engagement portions have complementary frustoconical surfaces, but it is perfectly possible to adopt, for at least one of these surfaces, a different geometry than a frustum of a cone while still having sufficient airtightness and a connection that can be disengaged without excessive force or jerking.

For example, referring to FIG. 5, the second engagement portion 46, that is, the male portion connected to the writing member 3, is formed by a generally cylindrical surface having two annular projecting reliefs (46c, 46d), which in the present case are in the form of beads. The reliefs (46c, 46d) are spaced apart from each other in the longitudinal direction and are each of a different height, although the height of each is constant all the way around the periphery, so that the lower relief 46d is situated toward the rear and the higher relief 46c toward the front. The vertices of these reliefs are therefore preferably inscribed within a frustoconical volume complementary to the surface of the first engagement portion 43. In this way there are two successive annular sealing regions and a common alignment of the tube 34 of the writing member 3 and of the sleeve 40 on the same axis corresponding to the longitudinal axis of the barrel 2. However, other shapes of complex surfaces that can engage with a frustoconical surface are possible, such as circular steps. It would however seem preferable for such a complex shape to be used on the second engagement portion 46, leaving the female or first engagement portion 43 frustoconical.

The two embodiments described above are not of course in any way restrictive. Besides the different variants indicated in the discussion of the first and second engagement portions, which can be combined together, such engagement portions can be used on writing instruments having mechanisms for extending/retracting one or more significantly different tips provided with different closure members.

1.-12. (canceled)

13. A writing instrument comprising:
a barrel extending longitudinally from a rear end to a forward end having an opening;
a writing member having a writing tip at a forward end longitudinally movable inside the barrel between a retracted position and an extended position for which the writing tip projects through the forward opening;
a sealing sleeve that can move longitudinally inside the barrel along a predetermined stroke between a withdrawn position and an advanced position and having rear and forward ends presenting rear and forward openings respectively, through which the writing member can slide, the sealing sleeve being propelled between the positions by the writing member when the latter is moved between the retracted and extended positions; and
a closure device capable of allowing the passage of the writing member through the forward openings of the sleeve and barrel when the sleeve is in the advanced position, and substantially to seal off the forward opening of the sleeve when the latter is in the retracted position with the writing tip housed inside the sleeve,
wherein the sealing sleeve comprises on a radially inward face a first engagement portion, and
wherein the writing member has on a radially outward face a second engagement portion, the first and second engagement portions being arranged longitudinally and designed in such a way as to engage with each other with friction to create a connecting force between the writing member and the sleeve greater than the force required to move the sleeve from its withdrawn position to its advanced position, and to create between themselves at least one substantially airtight annular zone when the writing member and the sleeve are in the retracted position and withdrawn position respectively, at least one of the first and second engagement portions being a frustoconical surface coaxial with the longitudinal axis and having its apex directed toward the rear.

14. The writing instrument according to claim 13, wherein the first engagement portion is a frustoconical surface coaxial with the longitudinal axis and having its apex directed toward the rear.

15. The writing instrument according to claim 14, wherein the second engagement portion is a frustoconical surface complementary with the first portion.

16. The writing instrument according to claim 15, wherein the cone angle of the first engagement portion is less than or equal to the cone angle of the second engagement portion, the respective cone angles of the first and second portions being approximately equal.

17. The writing instrument according to claim 13, wherein the other of the first and second engagement portions is a surface having at least two projecting annular reliefs spaced apart in the longitudinal direction, the vertices of the at least two reliefs being inscribed in a frustoconical volume complementary to the frustoconical surface.

18. The writing instrument according to claim 13, wherein the cone angle of the at least one frustoconical surface is from 2 to 5 degrees.

19. The writing instrument according to claim 13, wherein at least one of the first and second engagement portions has an elastically deformable surface.

20. The writing instrument according to claim 19, wherein the first engagement portion has an elastically deformable surface while the second engagement portion has a rigid surface.

21. The writing instrument according to claim 19, wherein the at least one elastically deformable surface is an elastomeric part formed in one piece with a rigid part belonging to the sealing sleeve or to the writing member.

22. The writing instrument according to claim 19, wherein the at least one elastically deformable surface is an elastomeric part formed in one piece with a rigid part belonging to the writing member

23. The writing instrument according to claim 19, wherein the sealing sleeve is formed entirely of elastomer.

24. The writing instrument according to claim 13, wherein the first and second engagement portions are hard surfaces with little roughness.

25. The writing instrument according to claim 23, wherein the first and second engagement portions are made of rigid plastic.

26. The writing instrument according to claim 13, wherein the friction engagement of the first and second portions creates a connecting force of from 2 to 10 newtons.
